(19) United States
(12) Patent Application Publication
(10) Pub. No.: US 2011/0029903 A1
(43) Pub. Date: Feb. 3, 2011

(54) INTERACTIVE VIRTUAL REALITY IMAGE GENERATING SYSTEM

(75) Inventors: Jacqueline Francisca Gerarda Maria Schooleman, Eindhoven (NL); Gino Johannes Apolonia Van Den Bergen, Helmond (NL)

Correspondence Address: KNOBBE MARTENS OLSON & BEAR LLP, 2040 MAIN STREET, FOURTEENTH FLOOR, IRVINE, CA, 92614, US

(73) Assignee: Virtual Proteins B.V., Eindhoven (NL)

(21) Appl. No.: 12/937,648

(22) PCT Filed: Apr. 16, 2009
(86) PCT No.: PCT/EP09/54553

§ 371 Date: Oct. 13, 2010

(30) Foreign Application Priority Data
Apr. 16, 2008 (NL) 1035303

(51) Int. Cl. G06F 3/048; G09G 5/08

(52) U.S. Cl. 715/764; 345/157

(57) ABSTRACT

The invention provides an image generating system and method that provides to an observer a substantially real-time mixed reality experience of a physical work space with superposed thereon a virtual space comprising virtual objects and allows the observer to manipulate the virtual objects in the virtual space by actions performed in the physical work space, and a program for implementing the method and a storage medium storing the program for implementing the method.

### FIELD OF THE INVENTION

The invention relates to systems for virtual reality and manipulation thereof. In particular, the invention relates to an image generating system and method that provides to an observer a substantially real-time mixed reality experience of a physical work space with superposed thereon a virtual space comprising virtual objects, and allows the observer to manipulate the virtual objects by actions performed in the physical work space, and a program for implementing the method and a storage medium storing the program for implementing the method.

### BACKGROUND OF THE INVENTION

Mixed reality systems in which an observer is presented with a view of a virtual space comprising virtual objects superposed onto a feed of real, physical space surrounding the observer are known.

For example, US 2002/0075286 A1 discloses such a system, wherein an observer wears a head-mounted display (HMD) projecting a stereoscopic image of a mixed reality space at an eye position and in line-of-sight direction of the observer. The movements of the head and hand of the observer are tracked using a complex peripheral transmitter-receiver sensor equipment. The system thus requires extensive installation and calibration of said peripheral equipment, which reduces its portability and ease of use for relatively non-specialist users. Moreover, the system provides for only very restricted if any interaction of the observer with the perceived virtual objects, and does not allow for manipulating the virtual reality using instruments.

Hence, there persists a pressing need for portable mixed reality systems of uncomplicated design that can be readily positioned on standard working areas, for example mounted on desktops, need not include HMD, do not require complex peripheral equipment installation and calibration before operation, can be operated by relatively inexperienced observers, and enable the observers to extensively and intuitively interact with and manipulate the virtual objects in the mixed reality work space. Such systems can enjoy a great variety of applications such as inter alia in training, teaching and research applications, presentations, demonstrations, entertainment and gaming.

### SUMMARY OF THE INVENTION

The invention thus aims to provide an image generating system and method that gives an observer a substantially real-time mixed reality experience of a physical work space with superposed thereon a virtual space comprising virtual objects and allows the observer to extensively and intuitively interact with and manipulate the virtual objects in the virtual space by actions performed in the physical work space, and a program for implementing the method and a storage medium storing the program for implementing the method.

Consistent with established terminology, the present image generating system may also be suitably denoted as an interactive image generating system or unit, an interactive virtual reality system or unit, or an interactive mixed reality system or unit.

Preferably, the present interactive virtual reality unit may be compact and easily operable by a user. For example, to prepare the system for operation the user may place it on a standard working area such as a table, aim image pickup members of the system at a work space on or near the surface of said working area and connect the system to a computer (optionally comprising a display) in order to receive the images of the mixed reality space, and manipulate more-dimensional virtual objects in a simple manner.

Preferably, the present system may be portable and may have dimensions and weight compatible with portability.

Also preferably, the system may have one or more further advantages, such as: it may have an uncomplicated design, may be readily positioned on standard working areas, for example mounted on desktops, need not include an HMD, may not require extensive peripheral equipment installation and calibration before use, and/or may be operated by relatively untrained observers.

Accordingly, an aspect of the invention provides an image generating system for allowing an observer to manipulate a virtual object, comprising image pickup means for capturing an image of a physical work space, virtual space image generating means for generating an image of a virtual space comprising the virtual object, composite image generating means for generating a composite image by synthesising the image of the virtual space generated by the virtual space image generating means and the image of the physical work space outputted by the image pickup means, display means for displaying the composite image generated by the composite image generating means, a manipulator for manipulating the virtual object by the observer, and manipulator pose determining means for determining the pose of the manipulator in the physical work space, characterised in that the system is configured to transform a change in the pose of the manipulator in the physical work space as determined by the manipulator pose determining means into a change in the pose and/or status of the virtual object in the virtual space.

The present image generating system may commonly comprise managing means for managing information about the pose and status of objects in the physical work space and managing information about the pose and status of virtual objects in the virtual space. The managing means may receive, calculate, store and update the information about the pose and status of said objects, and may communicate said information to other components of the system such as to allow for generating the images of the physical work space, virtual space and composite images combining such. To allow real-time operation of the system, the managing means may be configured to receive, process and output data and information in a streaming fashion.

Another aspect provides an image generating method for allowing an observer to manipulate a virtual object, comprising the steps of obtaining an image of a physical work space, generating an image of a virtual space comprising the virtual object, generating a composite image by synthesising the image of the virtual space and the image of the physical work space, and determining the pose of a manipulator in the physical work space, characterised in that a change in the pose of the manipulator in the physical work space is transformed into a change in the pose and/or status of the virtual object in the virtual space. The method is advantageously carried out using the present image generating system.

Further aspects provide machine-executable instructions (program) and a computer-readable storage medium storing said program, wherein the program is configured to execute said image generating method on said image generating system of the invention.

The term “physical work space” as used herein refers to a section of the physical world whose image is captured by the image pickup means. The imaginary boundaries and thus extent of the physical work space depend on the angle of view chosen for the image pickup means. In an embodiment, the section of the physical world displayed to an observer by the display means may match (e.g., may have substantially the same angular extent as) the physical work space as captured by the image pickup means. In another embodiment, the image displayed to an observer may be ‘cropped’, i.e., the section of the physical world displayed to the observer may be smaller than (e.g., may have a smaller angular extent than) the physical work space captured by the image pickup means.

The term “pose” generally refers to the translational and rotational degrees of freedom of an object in a given space, such as a physical or virtual space. The pose of an object in a given space may be expressed in terms of the object's position and orientation in said space. For example, in a 3-dimensional space the pose of an object may refer to the 3 translational and 3 rotational degrees of freedom of the object.

The term “status” of an object such as a virtual object encompasses attributes of the object other than its pose, which are visually or otherwise (e.g., haptic input) perceivable by an observer. Commonly, the term “status” may encompass the appearance of the object, such as, e.g., its size, shape, form, texture, transparency, etc., and/or its characteristics perceivable as tactile stimuli, e.g., hardness, softness, roughness, weight, etc.

Virtual objects as intended herein may include without limitation any two-dimensional (2D) image or movie objects, as well as three-dimensional (3D) or four-dimensional (4D, i.e., a 3D object changing in time) image or movie objects, or a combination thereof. Data representing such virtual objects may be suitably stored on and loadable from a data storage medium or in a memory.

To improve the observer's experience, the image pickup means may be configured to capture the image of the physical work space substantially at an eye position and in the direction of the sight of the observer. Also, the virtual space image generating means may be configured to generate the image of the virtual space substantially at the eye position and in the direction of the sight of the observer. This increases the consistency between the physical world sensed by the observer and the composite image of the physical and virtual work space viewed by the observer. For example, the observer can see the manipulator(s) and optionally his hand(s) in the composite image substantially at locations where he senses them by other sensory input such as, e.g., proprioceptive, tactile and/or auditory input. Hereby, the manipulation of the virtual objects situated in the composite image is made more intuitive and natural to the observer.

To capture the image of the physical work space substantially at an eye position of an observer, the image pickup means may be advantageously configured to be in close proximity to the observer's eyes when the system is in use (i.e., when the observer directs his sight at the display means). For example, when the system is in use, the distance between the image pickup means and the observer's eyes may be less than about 50 cm, preferably less than about 40 cm, even more preferably less than about 30 cm, such as, e.g., about 20 cm or less, about 15 cm or less, about 10 cm or less or about 5 cm or less.

To capture the image of the physical work space substantially in the direction of the sight of an observer, the image pickup means may be advantageously configured such that the optical axis (or axes) of the image pickup means is substantially parallel to the direction of the sight of the observer when the system is in use (i.e., when the observer directs his sight at the display means). For example, when the system is in use, the optical axis of the image pickup means may define an angle of less than about 30°, preferably less than about 20°, more preferably less than about 15°, such as, e.g., about 10° or less, about 7° or less, about 5° or less or about 3° or less or yet more preferably an angle approaching or being 0° with the direction of the sight of the observer. Particularly preferably the optical axis of the image pickup means may substantially correspond to (overlay) the direction of the sight of the observer when the system is in use, thereby providing a highly realistic experience to the observer.

By means of example, when the system is in use, the distance between the image pickup means and the observer's eyes may be about 30 cm or less, more preferably about 25 cm or less, even more preferably about 20 cm or less, such as preferably about 15 cm, about 10 cm, or about 5 cm or less, and the angle between the optical axis of the image pickup means and the direction of the sight of the observer may be about 20° or less, preferably about 15° or less, more preferably about 10° or less, even more preferably about 7° or less, yet more preferably about 5° or less, such as preferably about 4°, about 3°, about 2°, about 1° or less, or even more preferably may be 0° or approaching 0°, or the optical axis of the image pickup means may substantially correspond to the direction of the sight of the observer.

The system may advantageously comprise a positioning means configured to position the image pickup means and the display means relative to one another such that when the observer directs his sight at the display means (i.e., when he is using the system), the image pickup means will capture the image of the physical work space substantially at the eye position and in the direction of the sight of the observer as explained above. Said positioning means may allow for permanent positioning (e.g., in a position deemed optimal for operating a particular system) or adjustable positioning (e.g., to permit an observer to vary the position of the image pickup means and/or the display means, thereby adjusting their relative position) of the image pickup means and the display means. By means of example, a positioning means may be a housing comprising and configured to position the image pickup means and the display means relative to one another.

Further advantageously, the image pickup means may be configured such that during a session of operating the system (herein referred to as “operating session”) the location and extent of the physical work space does not substantially change, i.e., the imaginary boundaries of the physical work space remain substantially the same. In other words, during an operating session the image pickup means may capture images of substantially the same section of the physical world. By means of example, the system may comprise a support means configured to support and/or hold the image pickup means in a pre-determined or pre-adjusted position and orientation in the physical world, whereby the image pickup means can capture images of substantially the same physical work space during an operating session. For example, the support means may be placed on a standard working area (e.g., a table, desk, desktop, board, bench, counter, etc.) and may be configured to support and/or hold the image pickup means above said working area and directed such as to capture an image of said working area or part thereof.

Hence, in this embodiment the physical work space captured by the image pickup means (and presented to the observer by the display means) does not change when the observer moves his head and/or eyes. For example, the image pickup means is not head-mounted. Accordingly, in this embodiment the system does not require peripheral equipment to detect the pose and/or movement of the observer's head and/or eyes. The system is therefore highly suitable for portable, rapid applications without having to first install and calibrate such frequently complex peripheral equipment. Moreover, because the virtual space need not be continuously adjusted to concur with new physical work spaces perceived when an observer would move his head and/or eyes, the system requires considerably less computing power. This allows the system to react faster to changes in the virtual space due to the observer's manipulation thereof, thus giving the observer a real-time interaction experience with the virtual objects.

Similarly, the display means may be configured to not follow the movement of the observer's head and/or eyes. For example, the display means is not head-mounted. In particular, where the physical work space captured by the image pickup means (and presented to the observer by the display means) does not change when the observer moves his head and/or eyes (supra), displaying to the observer an unmoving physical work space when he actually moves his head and/or eyes might lead to an unpleasant discrepancy between the observer's visual input and the input from his other senses, such as, e.g., proprioception. This discrepancy does not occur when the display means does not follow the movement of the observer's head and/or eyes. In an example, the display means may be configured such that during an operating session the position and orientation of the display means does not substantially change. By means of example, the system may comprise a support means configured to support and/or hold the display means in a pre-determined or pre-adjusted position and orientation in the physical world. The support means for supporting and/or holding the display means may be same as or distinct from the support means for supporting and/or holding the image pickup means.

Hence, in this embodiment when the observer uses the system he looks at the display means to submerge himself in the virtual reality scene displayed by the display means, but he can instantly ‘return’ to his physical surroundings by simply diverting his gaze (eyes) away from the display means. This property renders the system highly suitable for inter alia applications that require frequent switching between the augmented and normal realities, or for applications that require frequent exchange or rotation of observers during a session (e.g., demonstrations, education, etc.).

Preferably, the system may provide for a stereoscopic view (3D-view) of the physical work space and/or the virtual space and preferably both. Such stereoscopic view allows an observer to perceive the depth of the viewed scene, ensures a more realistic experience and thus helps the observer to more accurately manipulate the virtual space by acting in the physical work space.

Means and processes for capturing stereoscopic images of a physical space, generating stereoscopic images of a virtual space, combining said images to produce composite stereoscopic images of the physical plus virtual space (i.e., mixed reality space), and for stereoscopic image display are known per se and may be applied herein with the respective elements of the present system (see inter alia Judge, “Stereoscopic Photography”, Ghose Press 2008, ISBN: 1443731366; Girling, “Stereoscopic Drawing: A Theory of 3-D Vision and its application to Stereoscopic Drawing”, 1^{st} ed., Reel Three-D Enterprises 1990, ISBN: 0951602802).

As mentioned, the present system comprises one or more manipulators, whereby an observer can interact with objects in the virtual space by controlling a manipulator (e.g., changing the pose of a manipulator) in the physical work space.

In an embodiment, the system may allow an observer to reversibly associate a manipulator with a given virtual object or group of virtual objects. Hereby, the system is informed that a change in the pose of the manipulator in the physical work space should cause a change in the pose and/or status of the so-associated virtual object(s). The possibility to reversibly associate virtual objects with a manipulator allows the observer to more accurately manipulate the virtual space. Said association may be achieved, e.g., by bringing a manipulator to close proximity or to contact with a virtual object in the mixed reality view and sending a command (e.g., pressing a button) initiating the association.

In an embodiment, a change in the pose of the manipulator in the physical work space may cause a qualitatively, and more preferably also quantitatively, identical change in the pose of a virtual object in the virtual space. This ensures that manipulation of the virtual objects remains intuitive for the observer. For example, at least the direction (e.g., translation and/or rotation) of the pose change of the virtual object may be identical to the pose change of the manipulator. Preferably, also the extent (degree) of the pose change of the virtual object (e.g., the degree of said translation and/or rotation) may be identical to the pose change of the manipulator. Alternatively, the extent (degree) of the pose change of the virtual object (e.g., the degree of said translation and/or rotation) may be scaled-up or scaled-down by a given factor relative to the pose change of the manipulator.

Advantageously, a manipulator may be hand-held or otherwise hand-connectable. This permits the observer to employ his hand, wherein the hand is holding or is otherwise connected to the manipulator, to change the pose of the manipulator in the physical work space, thereby causing a change in the pose and/or status of the virtual object in the virtual space. The movement of the observer's hand in the physical world thus influences and controls the virtual object in the virtual space, whereby the observer experiences an interaction with the virtual world.

Also advantageously, the observer can see the manipulator and, insofar the observer's hand also enters the physical work space, his hand in the image of the physical work space outputted by the image pickup means. The observer thus receives visual information about the pose of the manipulator and optionally his hand in the physical work space. Such visual information allows the observer to control the manipulator more intuitively and accurately.

Optionally and preferably, a virtual cursor may be generated in the image of the virtual space (e.g., by the virtual space image generating means), such that the virtual cursor becomes superposed onto the image of the manipulator in the physical work space outputted by the image pickup means. The pose of the virtual cursor in the virtual space preferably corresponds to the pose of the manipulator in the physical work space, whereby the perception of the virtual cursor provides the operator with adequate visual information about the pose of the manipulator in the physical work space. The virtual cursor may be superposed over the entire manipulator or over its part.

The system may comprise one manipulator or may comprise two or more (such as, e.g., 3, 4, 5 or more) manipulators. Typically, a manipulator may be configured for use by any one hand of an observer, but manipulators configured for use (e.g., for exclusive or favoured use) by a specific (e.g., left or right) hand of the observer can be envisaged. Further, where more than one manipulators are comprised in the system, the system may be configured to allow any two or more of said manipulators to manipulate the virtual space concurrently or separately. The system may also be configured to allow any two or more of said manipulators to manipulate the same or distinct virtual object(s) or sets of objects. Hence, an observer may choose to use any one or both hands to interact with the virtual space and may control one or more manipulators by said any one or both hands. For example, the observer may reserve a certain hand for controlling a particular manipulator or a particular set of manipulators or alternatively may use any one or both hands to control said manipulator or subset of manipulators.

The pose of the manipulator in the physical work space is assessed by a manipulator pose determining means, which may employ various means and processes to this end. Here below are proposed several inventive measures for determining the pose of a manipulator.

In a preferred embodiment the manipulator pose determining means is configured to determine the pose of the manipulator in the physical work space wholly or partly from the image of the physical work space outputted by the image pickup means. Hence, in the present embodiment the pose of the manipulator in the physical work space is wholly or partly determined from the image of the physical work space outputted by the image pickup means.

This advantageously avoids or reduces the need for conventional peripheral equipment for determining the pose of the manipulator. Because peripheral equipment routinely involves radiation (e.g., electromagnetic or ultrasonic) transmitter-receiver devices communicating with the manipulator, avoiding or reducing such peripheral equipment reduces the (electronic) design complexity and energy requirements of the system and its manipulator(s). Also avoided or reduced is the need to first install and calibrate such frequently complex peripheral equipment, whereby the present system is also highly suitable for portable, rapid applications. In addition, the pose of the manipulator can be wholly or partly determined using rapid image analysis algorithms and software, which require less computing power, are faster and therefore provide the observer with a more realistic real-time experience of manipulating the virtual objects.

To allow for recognising the manipulator and its pose in an image outputted by the image pickup means, the manipulator may comprise a recognition member. The recognition member may have an appearance in an image that is recognisable by an image recognition algorithm. Further, the recognition member may be configured such that its appearance (e.g., size and/or shape) in an image captured by the image pickup means is a function of its pose relative to the image pickup means (and hence, by an appropriate transformation a function of its pose in the physical work space). Hence, when said function is known (e.g., can be theoretically predicted or has been empirically determined) the pose of the recognition member (and of the manipulator comprising the same) relative to the image pickup means can be derived from the appearance of said recognition member in an image captured by the image pickup means. The pose relative to the image pickup means can then be readily transformed to the pose in the physical work space. The recognition member may comprise one or more suitable graphical elements, such as one or more distinctive graphical markers or patterns. Any image recognition algorithm or software having the requisite functions is suitable for use herein; exemplary algorithms are discussed inter alia in P J Besl and N D McKay. “A method for registration of 3-d shapes”. IEEE Trans. Pattern Anal. Mach. Intell. 14(2): 239-256,1992.

In another embodiment, the manipulator may comprise an accelerometer configured to measure the pose of the manipulator in the physical work space by measuring the acceleration exerted thereon by gravitational forces and/or by observer-generated movement of the manipulator. Accordingly, in this embodiment the pose of the manipulator in the physical work space is at least partly determined by measuring acceleration exerted on the manipulator by gravitational forces and/or by observer-generated movement of the manipulator. The use of an accelerometer avoids or reduces the need for peripheral equipment, bringing about the above-discussed advantages.

The accelerometer may be any conventional accelerometer, and may preferably be a 3-axis accelerometer, i.e., configured to measure acceleration along all three coordinate axes. When the manipulator is in rest the accelerometer reads the gravitational forces along the three axes. Advantageously, an accelerometer can rapidly determine the tilt (slant, inclination) of the manipulator relative to a horizontal plane. Hence, an accelerometer may be particularly useful for measuring the roll and pitch of the manipulator.

In a yet further embodiment, the manipulator may be connected (directly or indirectly) to an n-degrees of freedom articulated device. The number of degrees of freedom of the device depends on the desired extent of manipulation. Preferably, the device may be a 6-degrees of freedom articulated device to allow for substantially unrestricted manipulation in a three-dimensional work space. By means of example, the 6-degrees of freedom device may be a haptic device. The pose of the manipulator relative to the reference coordinate system of the articulated device (e.g., relative to the base of such device) is readily available, and can be suitably transformed to the pose in the physical work space. Hence, this embodiment allows for even faster determination of the pose of the manipulator, thereby providing the observer with a realistic real-time experience of manipulating the virtual objects.

The specification envisages systems that use any one of the above-described inventive means for determining the pose of the manipulator alone, or that combine any two or more of the above-described inventive means for determining the pose of the manipulator. Advantageously, combining said means may increase the accuracy and/or speed of said pose determination. For example, the different means may be combined to generate redundant or complementary pose information.

By means of example, pose determination using image recognition of the recognition member of a manipulator may be susceptible to artefacts. From a 2D image of the recognition member a slight distortion of the perspective may result in an incorrect orientation (position estimation is less susceptible to such artefacts). For example, distortion may occur due to lack of contrast (bad lighting conditions) or due to rasterisation. Given a 2D image of a recognition member, the image recognition and pose-estimation algorithm may return a number of likely poses. This input may then be combined with an input from an accelerometer to rule out the poses that are impossible according to the tilt angles of the manipulator as determined by the accelerometer.

Moreover, the specification also foresees using any one, two or more of the above-described inventive means for determining the pose of the manipulator in combination with other conventional pose-determination means, such as, e.g., with suitable peripheral equipment. The specification also envisages using such conventional means alone.

Accordingly, the invention also relates to a manipulator as described herein, in particular wherein the manipulator comprises a recognition member as taught above and/or an accelerometer as taught above and/or is connected to an n-degrees of freedom articulated device as taught above.

The present system, method and program can be adapted for networked applications to accommodate more than one observer. For example, each of the observers may receive a scene of a mixed reality space comprising, as a backdrop, his or her own physical work space, and further comprising one or more virtual objects shared with (i.e., visible to) the remaining observers.

Advantageously, the manipulation of a shared virtual object by any one observer in his or her own work space can cause the object to change its pose and/or status in the mixed reality views of one or more or all of the remaining networked observers. Advantageously, the observers may also visually perceive each other's manipulators (or the virtual manipulator cursors), and the manipulators (cursors) may be configured (e.g., labeled) to uniquely identify the respective observers controlling them.

Accordingly, an embodiment provides an image generating system for allowing two or more observers to manipulate a virtual object, comprising image pickup means for each observer for capturing an image of a physical work space of the respective observer, virtual space image generating means for generating an image of a virtual space comprising the virtual object, composite image generating means for generating for each observer a composite image by synthesising the image of the virtual space generated by the virtual space image generating means and the image of the physical work space outputted by the image pickup means for the respective observer, display means for each observer for displaying the composite image generated by the composite image generating means to the respective observer, a manipulator for each observer for manipulating the virtual object by the respective observer, and manipulator pose determining means for determining the pose of the manipulator in the physical work space of the respective observer, characterised in that the system is configured to transform a change in the pose of the manipulator in the physical work space of any one observer as determined by the manipulator pose determining means of that observer into a change in the pose and/or status of the virtual object in the virtual space. The method and program of the invention can be readily adapted in accordance with such system.

Whereas the present system may be particularly useful in situations where the physical work space captured by the image pickup means and displayed to an observer corresponds to the actual working area in which an observer performs his actions (i.e., the image pickup means and thus the physical work space captured thereby is generally nearby or close to the observer), situations are also envisaged where the physical work space captured by the image pickup means and displayed to the observer is remote from the observer (e.g., in another room, location, country, earth coordinate or even on another astronomical body, such as for example on the moon). By means of example, “remote” in this context may mean 5 or more metres (e.g., ≧10 m, ≧50 m, ≧100 m, ≧500 m or more). By operating a manipulator in his actual working area the observer can thus change the pose and/or status of a virtual object on the backdrop of the remote physical work space. A virtual cursor reproducing the pose of the manipulator may be projected in the mixed reality space to aid the observer's manipulations.

Accordingly, an embodiment provides an image generating system for allowing an observer to manipulate a virtual object, comprising a remote image pickup means for capturing an image of a physical work space, virtual space image generating means for generating an image of a virtual space comprising the virtual object, composite image generating means for generating a composite image by synthesising the image of the virtual space generated by the virtual space image generating means and the image of the physical work space outputted by the image pickup means, display means for displaying the composite image generated by the composite image generating means, a manipulator for manipulating the virtual object by the observer, and manipulator pose determining means for determining the pose of the manipulator in a working area proximal to the observer, characterised in that the system is configured to transform a change in the pose of the manipulator in said proximal working area as determined by the manipulator pose determining means into a change in the pose and/or status of the virtual object in the virtual space. The method and program of the invention can be readily adapted in accordance with such system.

The present image generating system, method and program are applicable in a variety of areas, especially where visualisation, manipulation and analysis of virtual representations of objects (preferably objects in 3D or 4D) may be beneficial. For example, in any of such areas, the system, method and program may be used for actual practice, research and/or development, or for purposes of training, demonstrations, education, expositions (e.g., museum), simulations etc. Non-limiting examples of areas where the present system, method and program may be applied include inter alia:
generally, visualisation, manipulation and analysis of virtual representations of objects; while any objects may be visualised, manipulated and analysed by the present system, method and program, particularly appropriate may be objects that do not (easily) lend themselves to analysis in real settings, e.g., because of their dimensions, non-availability, non-accessibility, etc.; for example, objects may be too small or too big for analysis in real settings (e.g., suitably scaled-up representations of small objects, e.g., microscopic objects such as biological molecules including proteins or nucleic acids or microorganisms; suitably scaled-down representations of big objects, such as, e.g., man-made objects such as machines or constructions, etc. or non-man-made objects, such as living or non-living objects, geological objects, planetary objects, space objects, etc.);
generally, data analysis, e.g., for visualisation, manipulation and analysis of large quantities of data visualised in the comparably ‘infinite’ virtual space; data at distinct levels may be analysed, grouped and relationships there between identified and visualised;

and in particular in exemplary areas including without limitation:
medicine, e.g., for medical imaging analysis (e.g., for viewing and manipulation of 2D, 3D or 4D data acquired in X-ray, CT, MRI, PET, ultrasonic or other imaging), real or simulated invasive or non-invasive therapeutic or diagnostic procedures and real or simulated surgical procedures, anatomical and/or functional analysis of tissues, organs or body parts; by means of example, any of applications in medical field may be for purposes of actual medical practice (e.g., diagnostic, therapeutic and/or surgical practice) or may be for purposes of research, training, education or demonstrations;
drug discovery and development, e.g., for 3D or 4D visualisation, manipulation and analysis of the structure of a target biological molecule (e.g., a protein, polypeptide, peptide, nucleic acid such as DNA or RNA), a target cell structure, a candidate drug, binding between a candidate drug and a target molecule or cell structure, etc.;
protein structure discovery, e.g., for 3D or 4D visualisation, manipulation and analysis of protein folding, protein-complex folding, protein structure, protein stability and denaturation, protein-ligand, protein-protein or protein-nucleic acid interactions, etc.;
structural science, materials science and/or materials engineering, e.g., for visualisation, manipulation and analysis of virtual representations of physical materials and objects, including man-made and non-man-made materials and objects;
prospecting, e.g., for oil, natural gas, minerals or other natural resources, e.g., for visualisation, manipulation and analysis of virtual representations of geological structures, (potential) mining or drilling sites (e.g., off-shore sites), etc.;
product design and development, engineering (e.g., chemical, mechanical, civil or electrical engineering) and/or architecture, e.g., for visualisation, manipulation and analysis of virtual representations of relevant objects such as products, prototypes, machinery, buildings, etc.;
nanotechnology and bionanotechnology, e.g., for visualisation, manipulation and analysis of virtual representations of nano-sized objects;
electronic circuits design and development, such as integrated circuits and wafers design and development, commonly involving multiple layer 3D design, e.g., for visualisation, manipulation and analysis of virtual representations of electronic circuits, partial circuits, circuit layers, etc.;
teleoperations, i.e., operation of remote apparatus (e.g., machines, instruments, devices); for example, an observer may see and manipulate a virtual object which represents a videoed physical object, wherein said remote physical object is subject to being manipulated by a remote apparatus, and the manipulations carried out by the observer on the virtual object are copied (on the same or different scale) by said remote apparatus on the physical object (e.g., remote control of medical procedures and interventions);
simulation of extraterrestrial environments or conditions. For example, an observer on Earth may be shown a backdrop of a remote, extraterrestrial physical work space (e.g., images taken by an image pickup means in space, on a space station, space ship or on moon), whereby virtual objects are superposed onto the image of the extraterrestrial physical work space and can be manipulated by the observer's actions in his proximal working area. Hence, the observer gains the notion of being submerged and manipulating or steering objects in the displayed extraterrestrial environment. Moreover, the extraterrestrial physical work space captured by the image pickup means may be used as a representation or a substitute model of yet another extraterrestrial environment (e.g., another planet, such as, e.g., Mars). Advantageously, the observer may also receive haptic input from the manipulator to experience inter alia the gravity conditions in the extraterrestrial environment captured by the image pickup means or, where this serves as a representation or substitute model for yet another extraterrestrial environment, in the latter environment. Accordingly, applications are foreseen in the field of aerospace technology, as well as in increasing public awareness of “space reality” (e.g., for exhibitions and musea);
sales and other presentations and demonstrations, for visualisation, manipulation and analysis of for example products;
systems biology, e.g., for visualisation and analysis of large data sets, such as produced by for example gene expression studies, proteomics studies, protein-protein interaction network studies, etc.;
finance and/or economy, e.g., for visualisation and analysis of complex and dynamic economical and/or financial systems;
entertainment and gaming;

Advantageously, the one or more manipulators of the system in the above and further uses may be connected (directly or indirectly) to haptic devices to add the sensation of touch (e.g., applying forces, vibrations, and/or motions to the observer via the manipulator) to the observer's interaction with and manipulation of the virtual objects. Haptic devices and haptic rendering in virtual reality solutions are known per se and can be suitably integrated with the present system (see, inter alia, McLaughlin et al. “Touch in Virtual Environments: Haptics and the Design of Interactive Systems”, 1^{st} ed., Pearson Education 2001, ISBN 0130650978; M Grunwald, ed., “Human Haptic Perception: Basics and Applications”, 1^{st} ed., Birkhäuser Basel 2008, ISBN 3764376112; Lin & Otaduy, eds., “Haptic Rendering: Foundations, Algorithms and Applications”, A K Peters 2008, ISBN 1568813325).

### BRIEF DESCRIPTION OF FIGURES

The invention will be described in the following in greater detail by way of example only and with reference to the attached drawings of non-limiting embodiments of the invention, in which:

FIG. 1 is a schematic representation of an embodiment of an image generating system of the invention,

FIG. 2 is a perspective view of an embodiment of an image generating system of the invention,

FIG. 3 is a perspective view of an embodiment of a manipulator for use with an image generating system of the invention,

FIG. 4 presents a perspective view of an embodiment of an image generating system of the invention mounted on a working area comprising a base marker, and depicts the camera (x^{v}, y^{v}, z^{v}, o^{v}) and world (x^{w}, y^{w}, z^{w}, o^{w}) coordinate systems (the symbol “o” or “O” as used throughout this specification may suitably denote the origin of a given coordinate system),

FIG. 5 illustrates a perspective view of a base marker and depicts the world (x^{w}, y^{w}, z^{w}, o^{w}) and navigation (xⁿ, yⁿ, zⁿ, oⁿ) coordinate systems,

FIG. 6 presents a perspective view of an embodiment of an image generating system of the invention mounted on a working area comprising a base marker, and further comprising a manipulator, and depicts the camera (x^{v}, y^{v}, z^{v}, o^{v}), world (x^{w}, y^{w}, z^{w}, o^{w}) and manipulator (x^{m}, y^{m}, z^{m}, o^{m}) coordinate systems,

FIG. 7 presents a perspective view of an embodiment of an image generating system of the invention mounted on a working area, and further comprising a manipulator connected to a 6-degrees of freedom articulated device, and depicts the camera (x^{v}, y^{v} z^{v}, o^{v}), manipulator (x^{m}, y^{m}, z^{m}, o^{m}) and articulated device base (x^{db}, y^{db}, z^{db}, o^{db}) coordinate systems,

FIG. 8 illustrates an example of the cropping of a captured image of the physical work space,

FIG. 9 illustrates a composite image where the virtual space includes shadows cast by virtual objects on one another and on the working surface,

FIGS. 10-13 illustrate calibration of an embodiment of the present image generating system,

FIG. 14 is a block diagram showing the functional arrangement of an embodiment of an image generating system of the invention including a computer,

### DETAILED DESCRIPTION OF THE INVENTION

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of and from the specified value, in particular variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

All documents cited in the present specification are hereby incorporated by reference in their entirety.

Unless otherwise defined, all terms used in disclosing the invention, including technical and scientific terms, have the meaning as commonly understood by one of ordinary skill in the art to which this invention belongs. By means of further guidance, term definitions may be included to better appreciate the teaching of the present invention.

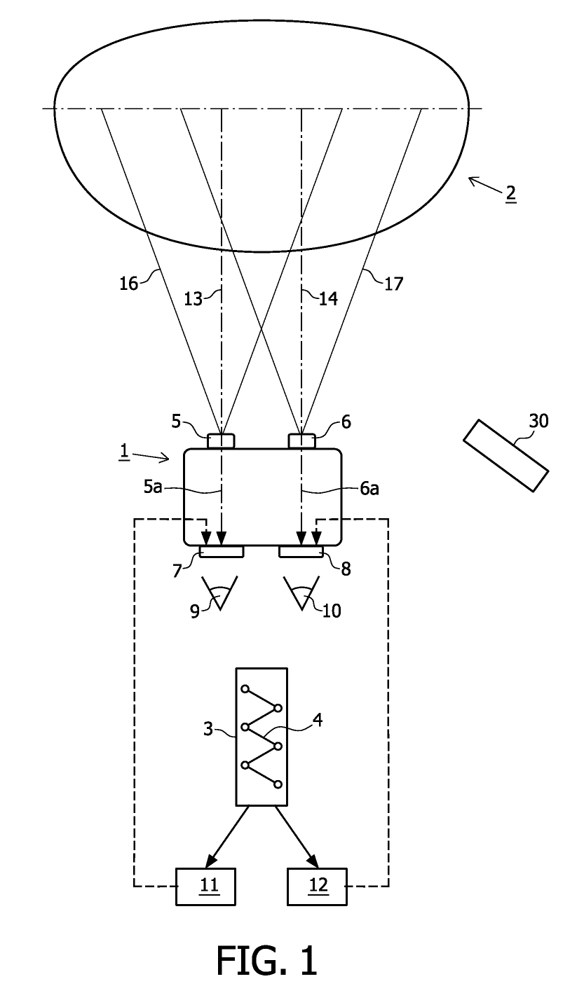

The image generating system according to FIG. 1 comprises a housing 1. On the side directed toward the work space 2 the housing 1 comprises the image pickup means 5, 6 and on the opposite side the display means 7, 8. The image pickup means 5, 6 is aimed at and adapted to capture an image of the physical work space 2.

The image pickup means 5, 6 may include one or more (e.g., one or at least two) image pickup members 5, 6 such as cameras, more suitably digital video cameras capable of capturing frames of video data, suitably provided with an objective lens or lens system. To allow for substantially real-time operation of the system, the image pickup means 5, 6 may be configured to capture an image of the physical work space 2 at a rate of at least about 30 frames per second, preferably at a rate corresponding to the refresh rate of the display means, such as, for example at 60 frames per second. The managing means of the system may thus be configured to process such streaming input information.

In the embodiment shown in FIG. 1, the image pickup means includes two image pickup members, i.e., the video cameras 5, 6, situated side by side at a distance from one another. The left-eye camera 5 is configured to capture an image of the physical work space 2 intended for the left eye 9 of an observer, whereas the right-eye camera 6 is configured to capture an image of the physical work space 2 intended for the right eye 10 of the observer. The left-eye camera 5 and right-eye camera 6 can thereby supply respectively the left-eye and right-eye images of the physical work space 2, which when presented to respectively the left eye 9 and right eye 10 of the observer produce a stereoscopic view (3D-view) of the physical work space 2 for the observer. The distance between the cameras 5 and 6 may suitably correspond the inter-pupillary distance of an average intended observer.

In an embodiment, the optical axis of the image pickup means (or axes, e.g., where the image pickup means comprises more than one image pickup members) may be adjustable. For example, in an embodiment the optical axes of individual image pickup members may be adjustable relative to one another and/or relative to the display means (and thus relative to the position of the eyes of an observer when directed at the display means). For example, in the embodiment of FIG. 1 the optical axes of the image pickup members (cameras) 5, 6 may be adjustable relative to one another and/or relative to the position of the display members 7, 8 (and thus eyes 9, 10). The optical axes of the objective lens of cameras 5, 6 are illustrated respectively by 13 and 14, defining perspective views 16, 17. Also, the distance between the image pickup members 5, 6 may be adjustable. An observer may thus aim the image pickup members 5, 6 at the physical world such as to capture an adequate stereoscopic, 3D-view of the physical work space 2. This depends on the distance between and/or the direction of the image pickup members 5, 6 and can be readily chosen by an experienced observer. Hereby, the view of the physical work space may also be adapted to the desired form and dimensions of a stereoscopically displayed virtual space comprising virtual object(s). The above-explained adjustability of the image pickup members 5, 6 may allow an observer to adjust the system to his needs, to achieve a realistic and high quality three-dimensional experience, and to provide for ease of operation.

In another embodiment, the position and optical axis of the image pickup means (or axes, e.g., where the image pickup means comprises more than one image pickup members) may be non-adjustable, i.e., pre-determined or pre-set. For example, in an embodiment optical axes of the individual image pickup members 5, 6 may be non-adjustable relative to one another and relative to the display members 7, 8. Also, the distance between the image pickup members 5, 6 may be non-adjustable. For example, the distance and optical axes of the image pickup members 5, 6 relative to one another and relative to the display members 7, 8 may be pre-set by the manufacturer, e.g., using setting considered optimal for the particular system, e.g., based on theoretical considerations or pre-determined empirically.

Preferably, during an operating session the housing 1 supports and/or holds the image pickup members 5, 6 in so pre-determined or pre-adjusted position and orientation in the physical world, such as to capture images of substantially the same physical work space 2 during an operating session.

The display means 7, 8 may include one or more (e.g., one or at least two) display members 7, 8 such as conventional liquid crystal and prism displays. To allow for substantially real-time operation of the system, the display means 5, 6 may preferably provide refresh rates substantially same or higher than the image capture rates of the image pickup means 5, 6. For example, the display means 7, 8 may provide refresh rates of at least about 30 frames per second, such as for example 60 frames per second. The display members may be preferably in colour. They may have without limitation a resolution of at least about 800 pixels horizontally and at least about 600 pixels vertically either for each of the three primary colours RGB or combined. The managing means of the system may thus be configured to process such streaming output information.

In the embodiment shown in FIG. 1, the display means includes two display members 7, 8, situated side by side at a distance from one another. The left-eye display member 7 is configured to display a composite image synthesised from an image of the physical work space 2 captured by the left-eye image pickup member 5 onto which is superposed a virtual space image comprising virtual object(s) as seen from the position of the left eye 9. The right-eye display member 8 is configured to display a composite image synthesised from an image of the physical work space 2 captured by the right-eye image pickup member 6 onto which is superposed a virtual space image comprising virtual object(s) as seen from the position of the left eye 10. Such connections are typically not direct but may suitably go through a managing means, such as a computer. The left-eye display member 7 and right-eye display member 8 can thereby supply respectively the left-eye and right-eye composite images of the mixed reality space, which when presented to respectively the left eye 9 and right eye 10 of the observer produce a stereoscopic view (3D-view) of the mixed reality work space for the observer. The connection of camera 5 with display 7 is schematically illustrated by the dashed line 5a and the connection of camera 6 with display 8 by the dashed line 6a. The stereoscopic images of the virtual space comprising virtual objects for respectively the left-eye display member 7 and right-eye display member 8 may be generated (split) from a representation of virtual space and/or virtual objects 4 stored in a memory 3 of a computer. This splitting is schematically illustrated with 11 and 12. The memory storing the representation of the virtual space and/or virtual objects 4 can be internal or external to the image generating system. Preferably, the system may comprise connection means for connecting with the memory of a computing means, such as a computer, which may also be configured for providing the images of the virtual space and/or virtual objects stored in said memory.

The distance between the display members 7 and 8 may suitably correspond to the inter-pupillary distance of an average intended observer. In an embodiment, the distance between the display members 7, 8 (and optionally other positional aspects of the display members) may be adjustable to allow for individual adaptation for various observers. Alternatively, the distance between the display members 7 and 8 may be pre-determined or pre-set by a manufacturer. For example, a manufacturer may foresee a single distance between said display members 7 and 8 or several distinct standard distances (e.g., three distinct distances) to accommodate substantially all intended observers.

Preferably, during an operating session the housing 1 supports and/or holds the display members 7, 8 in a pre-determined or pre-adjusted position and orientation in the physical world.

Further, the housing 1 is preferably configured to position the image pickup members 5, 6 and the display members 7, 8 relative to one another such that when the observer directs his sight at the display members 7, 8, the image pickup members 5, 6 will capture the image of the physical work space substantially at the eye position and in the direction of the sight of the observer.

Hence, the image generating system schematically set forth in FIG. 1 comprises at least two image pickup members 5, 6 situated at a distance from one another, wherein each of the image pickup members 5, 6 is configured to supply an image intended for each one eye 9, 10 of an observer, further comprising display members 7, 8 for providing to the eyes of the observer 9, 10 images intended for each eye, wherein the image display members 7, 8 are configured to receive stereoscopic images 11, 12 of a virtual object 4 (i.e., a virtual object representation) such that said stereoscopic images are combined with the images of the work space 2 intended for each eye 9, 10, such as to provide a three-dimensional image of the virtual object 4 as well as of the work space 2.

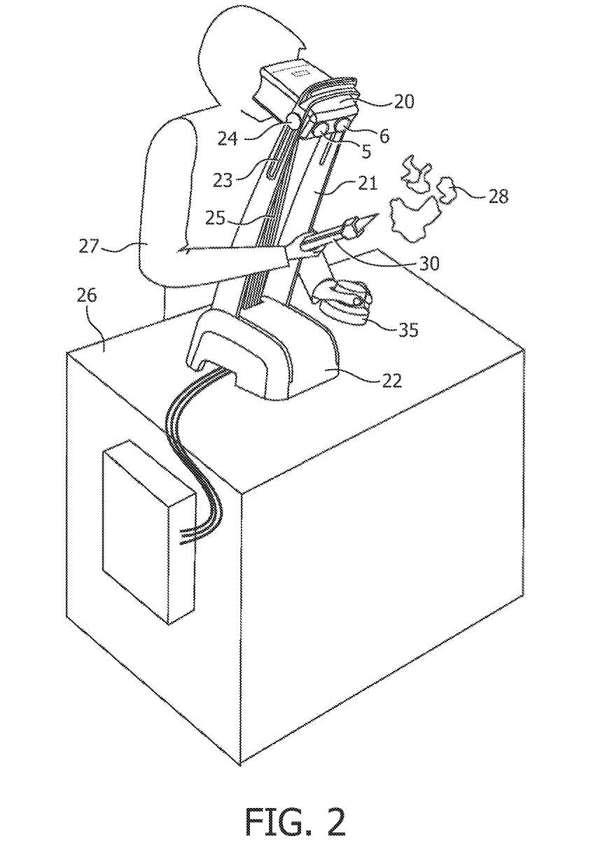

As shown in FIG. 2 the housing, the upper part 20 of which is visible, is mounted above a standard working area represented by the table 26 by means of a base member 22 and an interposed elongated leg member 21. The base member 22 is advantageously configured to provide for a steady placement on substantially horizontal and levelled working areas 26. Advantageously, the base member 22 and leg member 21 may be foldable or collapsible (e.g., by means of a standard joint connection there between) such as to allow for reducing the dimensions of the system to improve portability. The mounting, location and size of the system are not limited to the illustrated example but may be freely changed.

Accordingly, the present invention also contemplates a image capture and display unit comprising a housing 1 comprising an image pickup means 5, 6 and display means 7, 8 as taught herein, further comprising a base member 22 and an interposed elongated leg member 21 configured to mount the housing 1 above a standard working area 26 as taught herein. The unit may be connectable to a programmable computing means such as a computer.

The elevation of the housing relative to the base member 22, and thus relative to the working area 26, can be adjustable and reversibly securable in a chosen elevation with the help of elevation adjusting means 23 and 24. The inclination of the housing relative to the base member 22, and thus relative to the working area 26, may also be adjustable and reversibly securable in a chosen inclination with the help said elevation adjusting means 23 and 24 or other suitable inclination adjusting means (e.g., a conventional joint connection).

The cameras 5 and 6 each provided with an objective lens are visible on the front side of the housing. The opposite side of the housing facing the eyes of the observer comprises displays 7 and 8 (not visible in FIG. 2). An electrical connection cable 25 connects the housing and the base member 22.

To operate the system, the observer 27 may place the base member 22 onto a suitable working area, such as the table 26. The observer 27 can then direct the cameras 5, 6 at the working area 26, e.g., by adjusting the elevation and/or inclination of the housing relative to the working area 26 and/or by adjusting the position and/or direction (optical axes) of the cameras 5, 6 relative to the housing, such that the cameras 5, 6 can capture images of the physical work space. In the illustrated example, the space generally in front and above the base member 22 resting on the table 26 serves as the physical work space of the observer 27.

When using the system the observer 27 observes the display means presenting a composite image of the physical work space with superposed thereon an image of a virtual space comprising one or more virtual objects 28. Preferably, the virtual objects 28 are projected closer to the observer than the physical work space background. Preferably, the composite image presents the physical work space and/or virtual space, more preferably both, in a stereoscopic view to provide the observer 27 with a 3D-mixed reality experience. This provides for a desk top-mounted interactive virtual reality system whereby the observer views the 3D virtual image 28 in a physical work space, and can readily manipulate said virtual image 28 using one or more manipulators 30 the image of which is also displayed in the work space 2.

In an embodiment, the virtual objects 28 may be projected at a suitable working distance for an average intended observer, for example, at between about 0.2 m and about 1.2 m from the eyes of the observer. For seated work, a suitable distance may be about 0.3-0.5 m, whereas for standing work a suitable distance may be about 0.6-0.8 m.

Moreover, when the observer uses the system the display means (display members 7, 8) may be positioned such that the observer can have his gaze directed slightly downwards relative to the horizontal plane, e.g., at an angle of between about 2° and about 12°, preferably between about 5° and about 9°. This facilitates restful vision with relaxed eye muscles for the observer.

As further shown in FIGS. 1 and 2 means 30, 35 for allowing an observer to interact with the virtual space can be comprised in the system and optionally deployed in the physical work space 2. For example, the system may comprise one or more manipulators 30 and optionally one or more navigators 35. In an embodiment, the pose and/or status of a virtual object 28 may thus be simultaneously controlled via said one or more manipulators 30 as well as via the one or more navigators 35.

For example, the system may comprise a navigator 35. Advantageously, the navigator 35 may be configured to execute actions on the virtual space substantially independent from the pose of the navigator 35 in the physical work space 2. For example, the navigator 35 may be used to move, rotate, pan and/or scale one or more virtual objects 28 in reaction to a command given by the navigator 35. By means of example, a navigator may be a 2D or 3D joystick, space mouse (3D mouse), keyboard, or a similar command device.

The observer 27 has further at his disposal a manipulator 30.

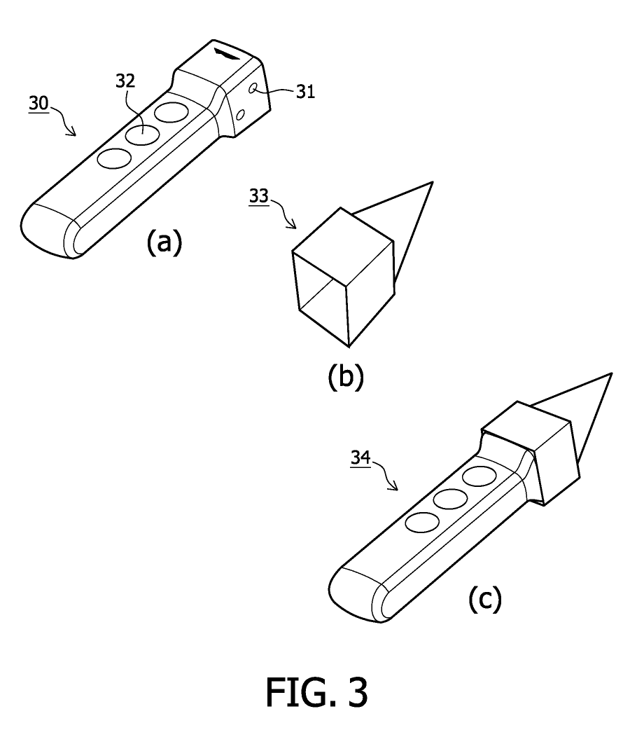

FIG. 3a shows the perspective view of an embodiment of a manipulator 30. The manipulator has approximately the dimensions of a human hand. The manipulator comprises a recognition member 31, in the present example formed by a cube-shaped graphical pattern. Said graphical pattern can be recognised in an image taken by the image pickup means (cameras 5, 6) by a suitable image recognition algorithm, whereby the size and/or shape of said graphical pattern in the image of the physical work space captured by the image pickup means allows the image recognition algorithm to determine the pose of the recognition member 31 (and thus of the manipulator 30) relative to the image pickup means.

A computer-generated image of a virtual 3D cursor 33 may be superposed onto the image of the manipulator 30 or part thereof, e.g., onto the image of the recognition member 31. Hence, in the mixed reality space presented to the observer it may appear as though the manipulator 30 and the cursor form a single member 34 (see FIG. 3c). The cursor 33 may take up any dimensions and/or shape and its appearance may be altered to represent a particular functionality (for example, the cursor 33 may provide for a selection member, a grasping member, a measuring device, or a virtual light source, etc.). Hence, various 3D representations of a 3D cursor may be superposed on the manipulator to provide for distinct functionalities of the latter.

The manipulator 30 allows for the interaction of the observer with one or more virtual objects 28. Said interaction is perceived and interpreted in the field of vision of the observer. For example, such interaction may involve an observed contact or degree of proximity in the mixed reality image between the manipulator 30 or part thereof (e.g., the recognition member 31) or the cursor 33 and the virtual object 28.

The manipulator 30 may be further provided with operation members 32 (see FIG. 3a) with which the user can perform special actions with the virtual objects, such as grasping (i.e., associating the manipulator 30 with a given virtual object 28 to allow for manipulation of the latter) or pushing away the representation or operating separate instruments such as a navigator or virtual haptic members. Hence, in an embodiment the operation members 32 may provide substantially the same functions as described above for the navigator 35.

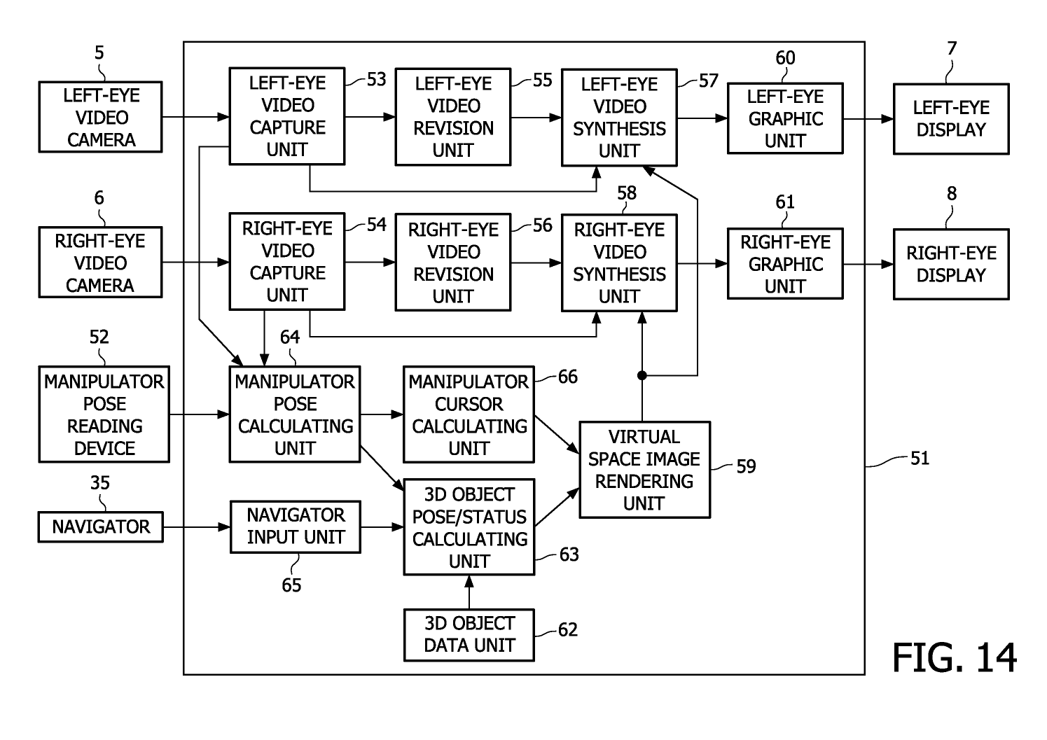

The processes involved in the operation of the present image generating system may be advantageously executed by a data processing (computing) apparatus, such as a computer. Said computer may perform the functions of managing means of the system. FIG. 14 is a block diagram showing the functional arrangement of an embodiment of this computer.

Reference numeral 51 denotes a computer which receives image signals (feed) captured by the image pickup means (cameras) 5 and 6, may optionally receive information about the pose of the manipulator 30 collected by an external manipulator pose reading device 52 (e.g., an accelerometer, or a 6-degree of freedom articulated device), may optionally receive commands from an external navigator 35, executes processing such as management and analysis of the received data, and generates image output signals for the display members 7 and 8 of the system.

The left-eye video capture unit 53 and the right-eye video capture unit 54 capture image input of physical work space respectively from the cameras 5 and 6. The cameras 5, 6 can supply a digital input (such as input rasterised and quantised over the image surface) which can be suitably processed by the video capture units 53 and 54.

The computer may optionally comprise a left-eye video revision unit 55 and right-eye video revision unit 56 for revising the images captured by respectively the left-eye video capture unit 53 and the right-eye video capture unit 54. Said revision may include, for example, cropping and/or resizing the images, or changing other image attributes, such as, e.g., contrast, brightness, colour, etc.

The image data outputted by the left-eye video capture unit 53 (or the left-eye video revision unit 55) and the right-eye video capture unit 54 (or the right-eye video revision unit 56) is supplied to respectively the left-eye video synthesis unit 57 and the right-eye video synthesis unit 58, configured to synthesise said image data with respectively the left-eye and right-eye image representation of the virtual space supplied by the virtual space image rendering unit 59.

The composite mixed reality image data synthesised by the left-eye video synthesis unit 57 and the right-eye video synthesis unit 58 is outputted to respectively the left-eye graphic unit 60 and the right-eye graphic unit 61 and then displayed respectively on the left-eye display 7 and the right-eye display 8. The graphic units 60, 61 can suitably generate digital video data output signal (such as rasterised images with each pixel holding a quantised value) adapted for displaying by means of the displays 7, 8.

The data characterising the virtual 3D objects is stored in and supplied from the 3D object data unit 62. The 3D object data unit 62 may include for example data indicating the geometrical shape, colour, texture, transparency and other attributes of virtual objects.

The 3D object data supplied by the 3D object data unit 62 is processed by the 3D object pose/status calculating unit 63 to calculate the pose and/or status of one or more virtual objects relative to a suitable coordinate system. The 3D object pose/status calculating unit 63 receives input from the manipulator pose calculating unit 64, whereby the 3D object pose/status calculating unit 63 is configured to transform a change in the pose of the manipulator relative to a suitable coordinate system as outputted by the manipulator pose calculating unit 64 into a change in the pose and/or status of one or more virtual objects in the same or other suitable coordinate system. The 3D object pose/status calculating unit 63 may also optionally receive command input from the navigator input unit 65 and be configured to transform said command input into a change in the pose and/or status of one or more virtual objects relative to a suitable coordinate system. The navigator input unit 65 receives commands from the external navigator 35.

The manipulator pose calculating unit 64 advantageously receives input from one or both of the left-eye video capture unit 53 and the right-eye video capture unit 54. The manipulator pose calculating unit 64 may execute an image recognition algorithm configured to recognise the recognition member 31 of a manipulator 30 in the image(s) of the physical work space supplied by said video capture unit(s) 53, 54, to determine from said images(s) the pose of said recognition member 31 relative to the cameras 5 and/or 6, and to transform this information into the pose of the recognition member 31 (and thus the manipulator 30) in a suitable coordinate system.

Alternatively or in addition, the manipulator pose calculating unit 64 may receive input from an external manipulator pose reading device 52 (e.g., an accelerometer, or a 6-degree of freedom articulated device) and may transform this input into the pose of the manipulator 30 in a suitable coordinate system.

Advantageously, the information on the pose of the manipulator 30 (or its recognition member 31) in a suitable coordinate system may be supplied to the manipulator cursor calculating unit 66, configured to transform this information into the pose of a virtual cursor 33 in the same or other suitable coordinate system.

The data from the 3D object pose/status calculating unit 63 and optionally the manipulator cursor calculating unit 66 is outputted to the virtual space image rendering unit 59, which is configured to transform this information into an image of the virtual space and to divide said image into stereoscopic view images intended for the individual eyes of an observer, and to supply said stereoscopic view images to left-eye and right-eye video synthesis units 57, 58 for generation of composite images.

Substantially any general-purpose computer may be configured to a functional arrangement for the image generating system of the present invention, such as the functional arrangement shown in FIG. 14. The hardware architecture of such a computer can be realised by a person skilled in the art, and may comprise hardware components including one or more processors (CPU), a random-access memory (RAM), a read-only memory (ROM), an internal or external data storage medium (e.g., hard disk drive), one or more video capture boards (for receiving and processing input from image pickup means), one or more graphic boards (for processing and outputting graphical information to display means). The above components may be suitably interconnected via a bus inside the computer. The computer may further comprise suitable interfaces for communicating with general-purpose external components such as a monitor, keyboard, mouse, network, etc. and with external components of the present image generating system such as video cameras 5, 6, displays 7, 8, navigator 35 or manipulator pose reading device 52. For executing processes needed for operating the image generating system, suitable machine-executable instructions (program) may be stored on an internal or external data storage medium and loaded into the memory of the computer on operation.

Relevant aspects of the operation of the present embodiment of the system are further discussed.

When the image generating system is prepared for use (e.g., mounted on a working area 26 as shown in FIG. 2) and started, and optionally also during the operation of the system, a calibration of the system is performed. The details of said calibration are described elsewhere in this specification.

The image of the physical work space is captured by image pickup means (cameras 5, 6).

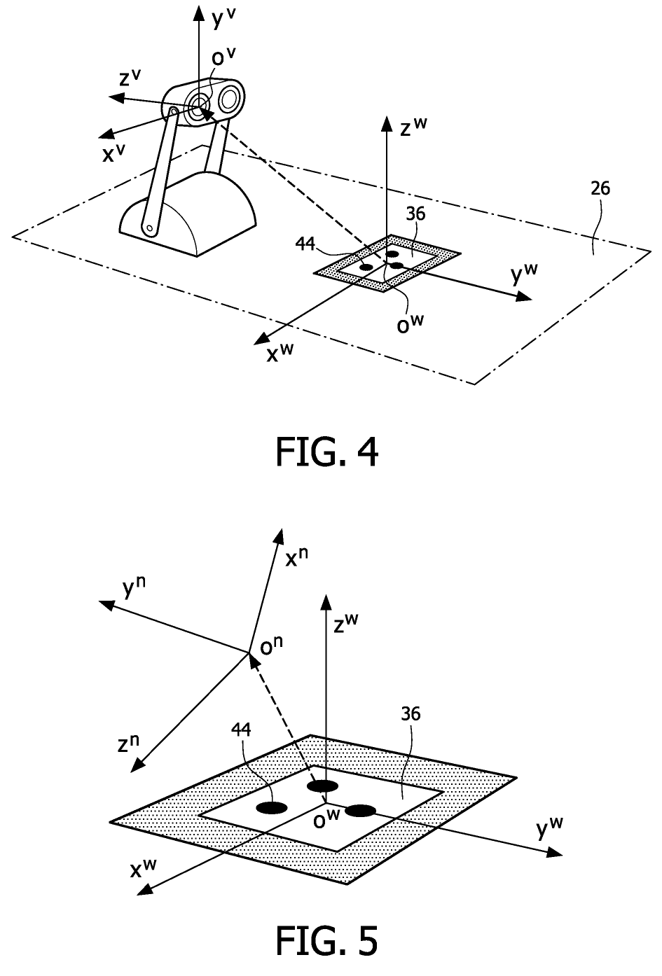

A base marker 36 comprising a positional recognition member (pattern) 44 is placed in the field of view of the cameras 5, 6 (see FIG. 4). The base marker 36 may be an image card (a square image, white backdrop in a black frame). An image recognition software can be used to determine the position of the base marker 36 with respect to the local space (coordinate system) of the cameras (in FIG. 4 the coordinate system of the cameras is denoted as having an origin (o^{v}) at the aperture of the right eye camera and defining mutually perpendicular axes x^{v}, y^{v}, z^{v}).

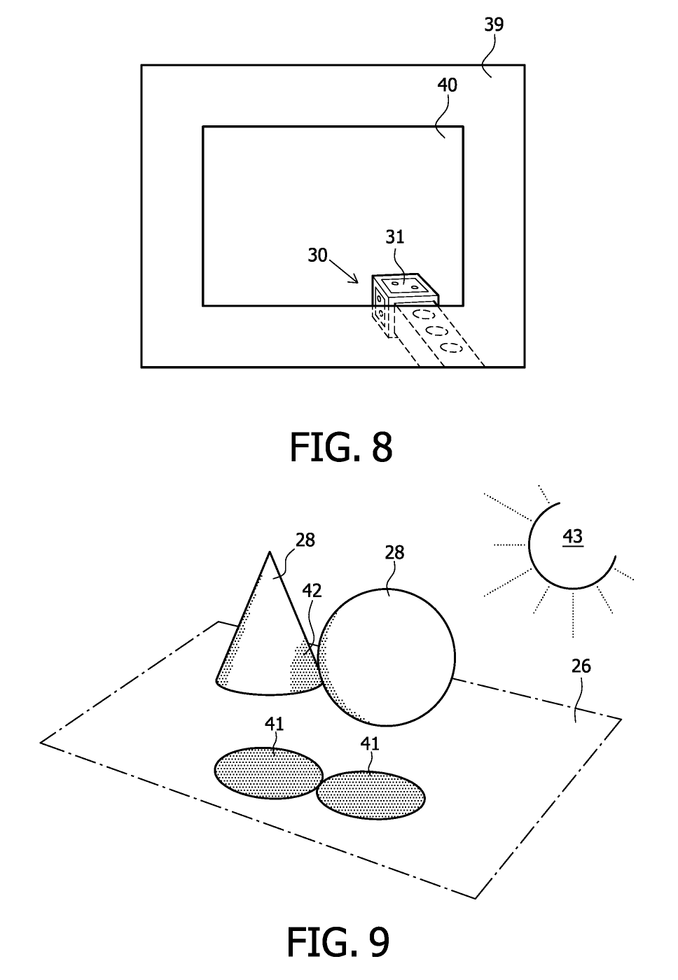

The physical work space image may be optionally revised, such as cropped. For example, FIG. 8 illustrates a situation where a cropped live-feed frame 40 rather than the full image 39 of the work space is presented to an observer as a backdrop. This allows for a better focus on the viewed/manipulated virtual objects. This way, the manipulator 30 can be (partially) out of the view of the observer (dashed part), yet the recognition member 31 of the manipulator 30 can be still visible to the cameras for the pose estimation algorithm. Accordingly, the present invention also provides the use of an algorithm or program configured for cropping camera input rasters in order to facilitate zoom capabilities in the image generating system, method and program as disclosed herein.

The base marker 36 serves as the placeholder for the world coordinate system, i.e., the physical work space coordinate system x^{w}, y^{w}, z^{w}, o^{w}. The virtual environment is placed in the real world trough the use of said base marker. Hence, all virtual objects present in the virtual space (e.g., virtual objects as loaded or as generated while operating the system) are placed relative to the base marker 36 coordinate system.

A virtual reality scene (space) is then loaded. This scene can contain distinct kinds of items: 1) a static scene: each loaded or newly created object is placed in the static scene; preferably, the static scene is controlled by the navigator 35, which may be a 6-degrees of freedom navigator; 2) manipulated items: manipulated objects are associated with a manipulator.

The process further comprises analysis of commands received from a navigator 35. The static scene is placed in a navigation coordinate system (xⁿ, yⁿ, zⁿ, oⁿ) relative to the world coordinate system x^{w}, y^{w}, z^{w}, o^{w} (see FIG. 5). The positions of virtual objects in the static scene are defined in the navigation coordinate system xⁿ, yⁿ, zⁿ, oⁿ. The navigation coordinate system allows for easy panning and tilting of the scene. A 6-degree of freedom navigator 35 is used for manipulating (tilting, panning) the static scene. For this purpose, the pose of the navigator 35 is read and mapped to a linear and angular velocity. The linear velocity is taken to be the relative translation of the navigator multiplied by some given translational scale factor. The scale factor determines the translational speed. The angular velocity is a triple of relative rotation angles for the three rotation angles (around x-, y-, and z-axes) of the navigator. As for the linear velocity, the angular velocity is obtained by multiplying the triple of angles by a given rotational scale factor. Both the linear and angular velocities are assumed to be given in view space (x^{v}, y^{v}, z^{v}, o^{v}). The navigator is controlled by the observer so by assuming the device is controlled in view space the most intuitive controls can be obtained. The velocities are transformed to world space x^{w}, y^{w}, z^{w}, o^{w} using a linear transform (3×3 matrix). The world-space linear and angular velocities are then integrated over time to find the new position and orientation of the navigation coordinate system xⁿ, yⁿ, zⁿ, oⁿ in the world space x^{w}, y^{w}, z^{w}, o^{w}.

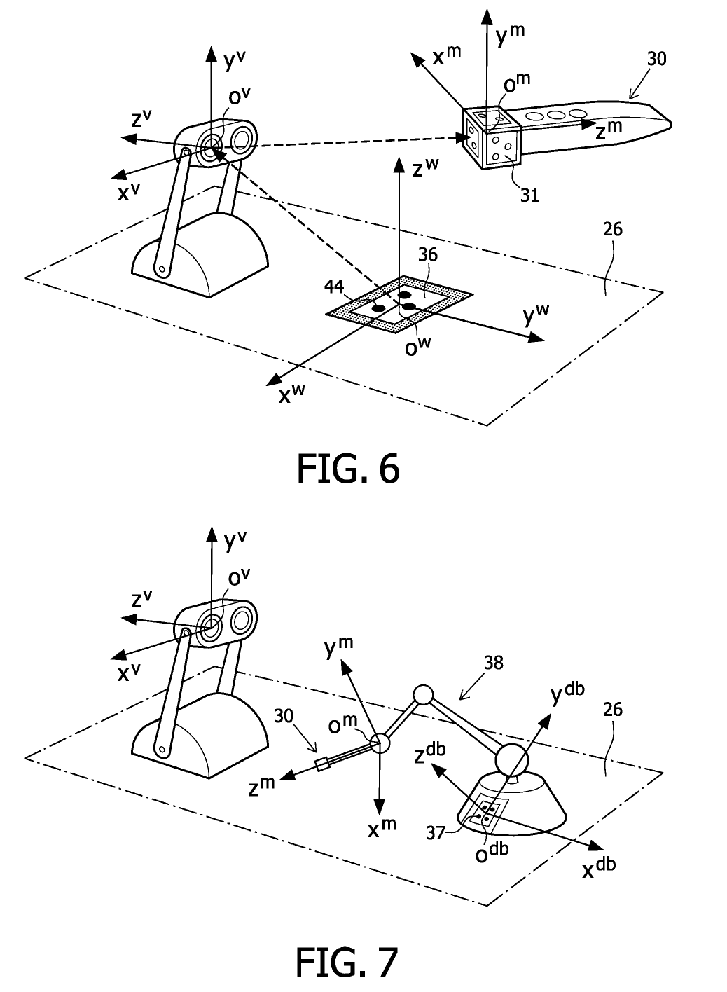

With reference to FIG. 6, one or more manipulators 30 may be used to select and drag objects in the static scene. By means of example, herein is described a situation when a given change in the pose of the manipulator in the physical space causes the same change in the pose of the manipulated virtual object.

An observer can associate a given virtual object in the static scene with the manipulator 30 by sending a suitable command to the system. Hereby, the selected virtual object is disengaged from the static scene and placed in the coordinate system of the manipulator x^{m}, y^{m}, z^{m}, o^{m} (FIG. 6). When the pose of the manipulator 30 in the physical work space changes, so does the position and orientation of the manipulator coordinate system x^{m}, y^{m}, z^{m}, o^{m} relative to the world coordinate system x^{w}, y^{w}, z^{w}, o^{w}. Because the virtual object associated with the manipulator is defined in the manipulator coordinate system x^{m}, y^{m}, z^{m}, o^{m}, the pose of the virtual object in the world coordinate system x^{w}, y^{w}, z^{w}, o^{w} will change accordingly. Once the manipulator is disassociated from the virtual object, the object may be placed back in the static scene, such that its position will be once again defined in the navigator coordinate system xⁿ, yⁿ, zⁿ, oⁿ.

The process thus further comprises manipulator pose calculation.

In the example shown in FIG. 6, the manipulator 30 comprises a recognition member, which includes a number of graphical markers (patterns) placed in a known (herein cube) configuration. Hence, one up to three markers may be scanned by the camera when the manipulator 30 is placed in the view. The pose of the markers relative to the camera coordinate system x^{v}, y^{v} z^{v}, o^{v} can be determined by an image recognition and analysis software and transformed to world coordinates x^{w}, y^{w}, z^{w}, o^{w}. Hereby, the position and orientation of the manipulator coordinate system x^{m}, y^{m}, z^{m}, o^{m} (in which virtual objects that have been associated with the manipulator are defined) can be calculated relative to the world coordinate system x^{w}, y^{w}, z^{w}, o^{w}.

In the example shown in FIG. 7, the manipulator 30 is connected to an articulated 6-degrees of freedom device 38, which may be for example a haptic device (e.g., Sensable Phantom).

The relative placement of the manipulator with respect to the coordinate system (x^{db}, y^{db}, z^{db}, o^{db}) of the base of the 6-DOF device is readily available. The pose of the base of the 6-DOF device relative to the view coordinate system (x^{v}, y^{v}, z^{v}, o^{v}) can be determined through the use of a marker 37 situated at the base of the device, e.g., a marker similar to the base marker 36 placed on the working area (see FIG. 6).

Based on the input from the navigator 35 and/or manipulator 30, the pose and/or status of the virtual objects controlled by the navigator and/or manipulator is calculated using linear transformation algorithms known per se. Similarly, based on the input from the manipulator 30 the pose of the virtual cursor 33 is calculated.

The virtual space image comprising the virtual objects is then rendered. Virtual objects are rendered and superposed on top of the live-feed backdrop of the physical work space to generate composite mixed reality images such as using traditional real-time 3D graphics software (e.g., OpenGL, Direct3D).

Preferably, as shown in FIG. 9, three-dimensional rendering may include one or more virtual light sources 43, whereby the virtual objects are illuminated and cast real-time shadows between virtual objects (object shadows 42) and between a virtual object and the desktop plane (desktop shadow 41). This may be done using well-known processes, such as that described in Reeves, W T, D H Salesin, and P L Cook. 1987. “Rendering Antialiased Shadows with Depth Maps.” Computer Graphics 21(4) (Proceedings of SIGGRAPH 87). Shadows can aid the viewer in estimating the relative distance between virtual objects and between a virtual object and the desktop. Knowing the relative distance between objects, in particular, knowing the distance between a virtual object and the 3D representation of a manipulator is useful for selecting and manipulating virtual objects. Knowing the distance between a virtual object and the ground plane is useful for estimating the size of a virtual object with respect to the real world. Accordingly, the present invention also provides the use of an algorithm or program configured to produce shadows using artificial light sources for aiding an observer in estimating relative distances between virtual objects and relative sizes of virtual objects with respect to the physical environment, in particular in the image generating system, method and program as disclosed herein.

Finally, the composite image is outputted to the display means and presented to the observer. The mixed reality scene is then refreshed to obtain real-time (life-feed) operating experience. Preferably, the refresh rate may be at least about 30 frames per second, preferably it may correspond to the refresh rate of the display means, such as, for example 60 frames per second.

The calibration carried out at the start-up and optionally during operation of the present image generating system is now described in detail.

By means of the calibration process, 1) the cameras 5, 6 are configured such that the observer receives the image from the left camera 5 and right camera 6 in his left and right eye, respectively; 2) the cameras 5, 6 are positioned such that the images received by the observer can be perceived as a stereo image in a satisfactory way for a certain range of distances in the field of view of the cameras (i.e., the perception of stereo does not fall apart into two separate images); 3) the two projections (i.e., one sent to each eye of an observer) of every 3D virtual representation of an object in the physical world align with the two projections (to both images) of the corresponding physical world objects themselves.

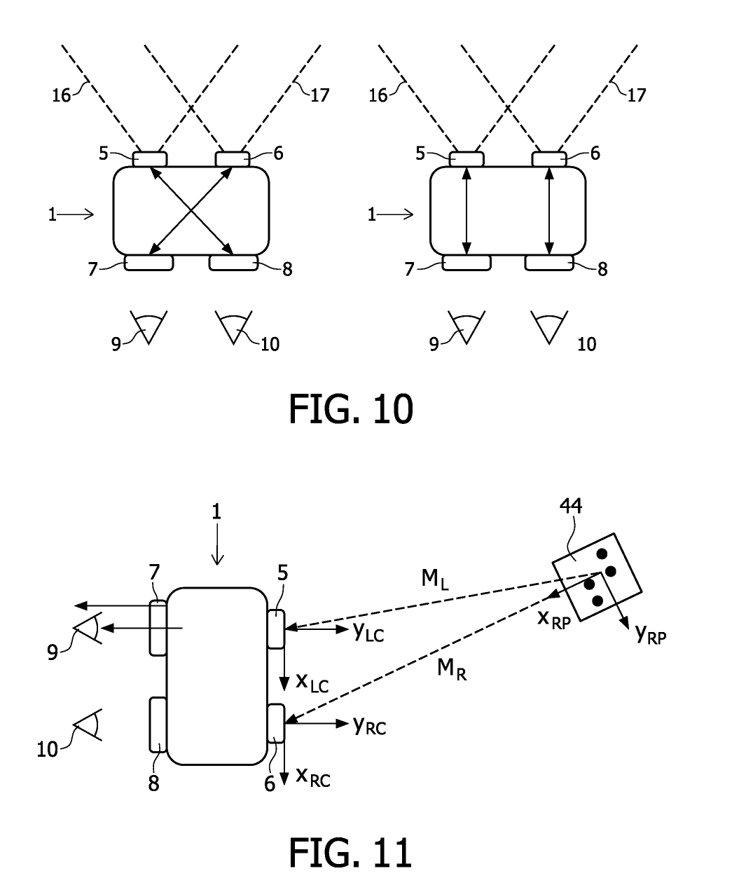

The first process, confirmation that the images from the left camera 5 and right camera 6 are sent to the left and right eyes respectively, and swapping the images if necessary, is accomplished automatically at start-up of the system. The wanted situation is illustrated in FIG. 10 right panel, whereas FIG. 10 left panel shows a wrong situation that needs to be corrected.

With reference to FIG. 11, the automatic routine waits until within a small time period, any positional recognition member (pattern) 44 is detected in both images received from the cameras. The detection is performed by well-known methods for pose estimation. This yields two transformation matrices, one for each image; each one of said matrices represents the position of the positional recognition member (pattern) 44 in the local space (coordinate system) of a camera, schematically illustrated as x_{LC}, y_{LC} for the left camera 5 and x_{RC}, y_{RC} for the right camera 6, or by using the inverse of the matrix the position of the camera in the local space (coordinate system) of the positional recognition member (pattern) 44, schematically illustrated as x_{RP}, y_{RP}. Based on these transformation matrices, an algorithm can confirm which one belongs to the local space of the left camera (M_{L}) and which one to the local space of the right camera (M_{R}). Initially, one of these matrices is assumed to transform the positional recognition member to the local space of the left camera (i.e., the left camera transformation), so the inverse of this matrix represents the transformation from the left camera to the local space of the positional recognition member (M_{L}⁻¹). Transforming the origin (O) using the inverse left camera transformation therefore yields the position of the left camera in the local space of the positional recognition member

M_{L}⁻¹*O

and the consecutive transformation of this position by the right camera transformation yields the position (P) of the left camera in the local space of the right camera

P=M_{R}*M_{L}⁻¹*O

If the assumption that the left camera transformation (and therefore the corresponding image) belongs to the left camera is correct, the left camera position in the right camera's local space should have a negative x_{RC} component (P_{x(RC)})

P_{x(RC)}<0

If the assumption is shown to be incorrect, the images are automatically swapped between the left and the right eye. The image generating system also enables the observer to manually swap (e.g., by giving a computer command or pressing a key) the images sent to the left and right eye at any moment, for example to resolve cases in which the automatic detection does not provide the correct result.

The second process, positioning of the cameras to maximise the stereo perception may be performed by an experienced observer or may be completed during manufacturing of the present image generating system, e.g., to position the cameras 5, 6 such as to maximise the perception of stereo by the user at common working distances, in a particularly preferred example at a distance of 30 cm away from the position of the cameras 5, 6. The sharpness of the camera images can be suitably controlled through the camera drivers.

The third process, aligning the projected 3D representations of objects in the real world with the projected objects themselves is preferably performed differently for the left and the right camera images respectively.

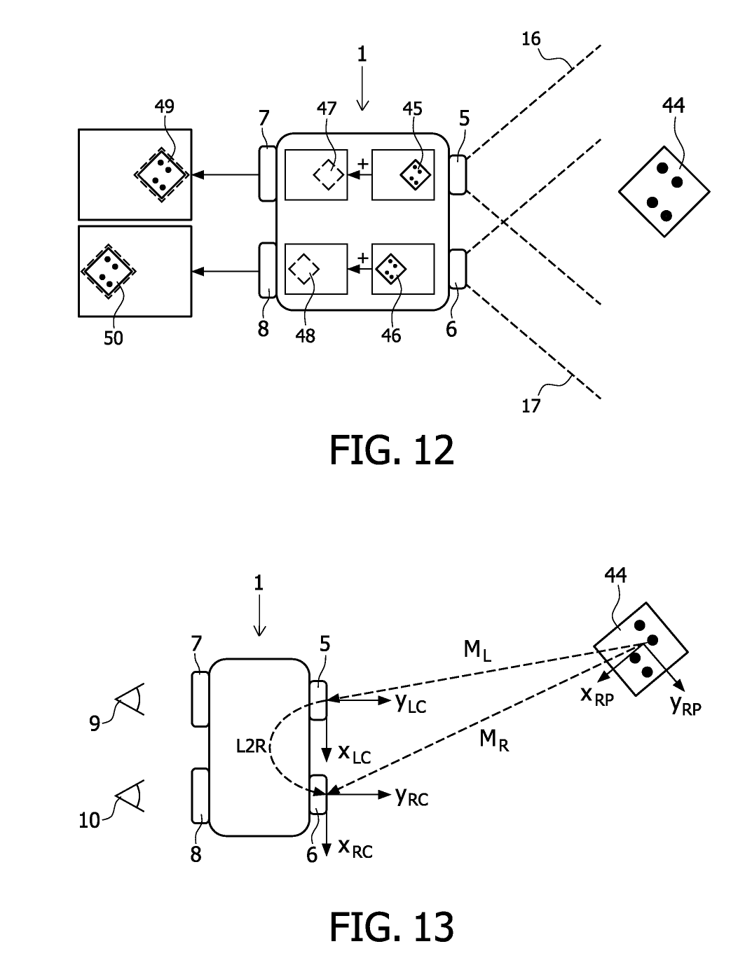

Refer to FIGS. 12 and 13. The positional recognition member (pattern) 44 is a real world object projected onto the camera image 45, 46, combined (+) with a virtual representation 47, 48 projected onto the same image. These two images have to be aligned, illustrated as alignments 49, 50.

The provided alignment algorithm for the left and right camera images pertain only to a subset of the components required by the rendering process to project the virtual representation as in FIG. 12 to the same area on the camera image as the physical positional recognition member 44. In full, the rendering process requires a set of matrices, consisting of a suitable modelview matrix and a suitable projection matrix, using a single set for the left image and another set for the right image. During the rendering process, the virtual representation is given the same dimensions as the physical positional recognition member it represents, placed at the origin of its own local space (coordinate system), and projected to the left or right image using the corresponding matrix set in a for common graphics libraries familiar way (see for example the OpenGL specification, section ‘Coordinate Transformations’ for details). The projection matrix used by the renderer is equivalent to the projection performed by the camera lens when physical objects are captured to the camera images; it is a transformation from the camera's local space to the camera image space. It is calibrated by external libraries outside of the virtual reality system's scope of execution and it remains fixed during execution. The modelview matrix is equivalent to the transformation from the physical positional recognition member's local space (coordinate system) to the camera's local space. This matrix is calculated separately for the left and right camera inside the virtual reality system's scope of execution by the alignment algorithm provided subsequently.

For the left camera, the transformation matrix M_{L} (FIG. 11) from every physical positional recognition member's 44 local space to the left camera's local space is calculated, such that alignment 49 of the virtual representation projection 47 with the real world object 45 projection is achieved. This happens at every new camera image; well-known methods for pose estimation can be applied to the left camera image to extract, from every new image, the transformation M_{L} for every positional recognition member (pattern) 44 in the physical world. If such a transformation cannot be extracted, alignment of the virtual representation will not take place.

For the right camera, the transformation matrix M_{R} (FIG. 11) from every physical positional recognition member's 44 local space to the right camera's local space is calculated, such that the alignment 50 of the virtual representation projection 48 to the real world projection in the right camera image 46 is achieved. Calculating M_{R} is performed in a different way than calculating M_{L}.

With reference to FIG. 13, to improve coherence, the algorithm for calculating M_{R} first establishes a fixed transformation M_{L2R} from the left camera's local space (x_{LC}, y_{LC}) to the right camera's local space (x_{RC}, y_{RC}). This transformation is used to transform objects correctly aligned 49 in the left camera's local space, to the correct alignment 50 in the right camera's local space, thereby defining M_{R} as follows:

M_{R}=M_{L2R}*M_{L}

The transformation M_{L2R} has to be calculated only at a single specific moment in time, since it does not change over time as during the operation of the system the cameras have a fixed position and orientation with respect to each other. The algorithm for finding this transformation matrix is performed automatically at start-up of the image generating system, and can be repeatedly performed at any other moment in time as indicated by a command from the observer. The algorithm initially waits for any positional recognition member (pattern) 44 to be detected in both images within a small period in time. This detection is again performed by well-known methods for pose estimation. The result of the detection is two transformation matrices, one for both images; one of these matrices represents the transformation of the recognition pattern's local space (x_{RP}, y_{RP}) to the left camera's local space x_{LC}, y_{LC} (the left camera transformation, M_{L}), and the other represents the position of the recognition pattern 44 in the right camera's local space x_{RC}, y_{RC} (the right camera transformation, M_{R}). Multiplication of the inverse left camera transformation (M_{L}⁻¹) with the right camera transformation yields a transformation (M_{L2R}) from the left camera local space x_{LC}, y_{LC} into the recognition pattern's local space x_{RP}, y_{RP}, into the right camera's local space x_{RC}, y_{RC}, which is the desired result:

M_{L2R}=M_{R}*M_{L}⁻¹

If during an extended period of time not a single recognition pattern 44 is detected in the images generated by the left camera, the alignment algorithm swaps the alignment method for the left camera with the alignment method for the right camera. So at that point, the virtual object 48 is aligned to the right camera's image 46 by detecting the recognition pattern 44 every frame and extracting the correct transformation matrix, while the alignment 49 of the virtual object 47 in the left image is now performed using a fixed transformation from the right camera's local space x_{RC}, y_{RC} to the left camera's local space x_{LC}, y_{LC}; which is the inverse of the transformation from the left camera's local space to the right camera's local space:

M_{R2L}=M_{L2R}⁻¹

The advantage of using a fixed M_{R2L} and M_{L2R} instead of extracting transformation matrices M_{L} and M_{R} separately, is that in the former case successful extraction of either M_{L} or M_{R} in a single image is enough to align the virtual representation projection with the real world object projection in both images.

The object of the present invention may also be achieved by supplying a system or an apparatus with a storage medium which stores program code of software that realises the functions of the above-described embodiments, and causing a computer (or CPU or MPU) of the system or apparatus to read out and execute the program code stored in the storage medium.

In this case, the program code itself read out from the storage medium realizes the functions of the embodiments described above, so that the storage medium storing the program code also and the program code per se constitutes the present invention.

The storage medium for supplying the program code may be selected, for example, from a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS).

It is to be understood that the functions of the embodiments described above can be realised not only by executing a program code read out by a computer, but also by causing an operating system (OS) that operates on the computer to perform a part or the whole of the actual operations according to instructions of the program code.

Furthermore, the program code read out from the storage medium may be written into a memory provided in an expanded board inserted in the computer, or an expanded unit connected to the computer, and a CPU or the like provided in the expanded board or expanded unit may actually perform a part or all of the operations according to the instructions of the program code, so as to accomplish the functions of the embodiment described above.

It is apparent that there has been provided in accordance with the invention, an image generating system, method and program and uses thereof that provide for substantial advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as follows in the spirit and broad scope of the appended claims.

1-19. (canceled)

20. An image generating system for allowing an observer to manipulate a virtual object, comprising image pickup means for capturing an image of a physical work space, virtual space image generating means for generating an image of a virtual space comprising the virtual object, composite image generating means for generating a composite image by synthesising the image of the virtual space generated by the virtual space image generating means and the image of the physical work space outputted by the image pickup means, display means for displaying the composite image generated by the composite image generating means, a manipulator for manipulating the virtual object by the observer, and manipulator pose determining means for determining the pose of the manipulator in the physical work space, characterised in that the system is configured to transform a change in the pose of the manipulator in the physical work space as determined by the manipulator pose determining means into a change in the pose and/or status of the virtual object in the virtual space, wherein the pose of the manipulator in the physical work space is wholly or partly determined from the image of the physical work space outputted by the image pickup means, and wherein the manipulator comprises a recognition member and wherein the recognition member is recognised in the image of the physical work space by an image recognition algorithm, and wherein the appearance of the recognition member in the image of the physical work space is a function of the pose of the recognition member relative to the image pickup means.

21. The image generating system according to claim 20, wherein the pose of the manipulator in the physical work space is at least partly determined by measuring acceleration exerted on the manipulator by gravitational forces and/or by observer-generated movement of the manipulator.

22. The image generating system according to claim 21, wherein the manipulator comprises an accelerometer.

23. The image generating system according to claim 20, wherein the manipulator is connected to an n-degrees of freedom articulated device.

24. The image generating system according to claim 20, wherein a change in the pose of the manipulator in the physical work space causes a qualitatively, and preferably also quantitatively, identical change in the pose of the virtual object in the virtual space.

25. The image generating system according to claim 20, wherein a virtual cursor is generated in the image of the virtual space, such that the virtual cursor becomes superposed onto the image of the manipulator in the physical work space outputted by the image pickup means.

26. The image generating system according to claim 20, which is mountable on a standard working area such as a desktop.

27. The image generating system according to claim 20, wherein the image pickup means is configured to capture the image of the physical work space substantially at an eye position and in the direction of the sight of the observer and the virtual space image generating means is configured to generate the image of the virtual space substantially at the eye position and in the direction of the sight of the observer.

28. The image generating system according to claim 20, wherein the image pickup means is configured such that during a session of operating the system the location and extent of the physical work space does not substantially change.

29. The image generating system according to claim 20, wherein the display means is configured such that during a session of operating the system the position and orientation of the display means does not substantially change.

30. The image generating system according to claim 20 configured to provide a stereoscopic view of the physical work space and/or the virtual space, preferably both.

31. The image generating system according to claim 20, wherein the system is adapted for network applications to accommodate more than one observer.

32. The image generating system according to claim 20, wherein the physical work space captured by the image pickup means is remote from the observer.

33. An image generating method for allowing an observer to manipulate a virtual object, configured to be carried out using the image generating system as defined in claim 20, the method comprising the steps of obtaining an image of a physical work space, generating an image of a virtual space comprising the virtual object, generating a composite image by synthesising the image of the virtual space and the image of the physical work space, and determining the pose of a manipulator in the physical work space, characterised in that a change in the pose of the manipulator in the physical work space is transformed into a change in the pose and/or status of the virtual object in the virtual space.

34. A program and a computer-readable storage medium storing said program, wherein the program is configured to execute an image generating method for allowing an observer to manipulate a virtual object, configured to be carried out using the image generating system as defined in claim 20, the method comprising the steps of obtaining an image of a physical work space, generating an image of a virtual space comprising the virtual object, generating a composite image by synthesising the image of the virtual space and the image of the physical work space, and determining the pose of a manipulator in the physical work space, characterised in that a change in the pose of the manipulator in the physical work space is transformed into a change in the pose and/or status of the virtual object in the virtual space.

35. A method of using the system as defined in claim 20, for visualisation, manipulation and analysis of virtual representations of objects or for data analysis.

36. A method of using the system as defined in claim 20, in medicine, drug discovery and development, protein structure discovery, structural science, materials science, materials engineering, prospecting, product design and development, engineering, architecture, nanotechnology, bionanotechnology, electronic circuits design and development, teleoperations, simulation of extraterrestrial environments or conditions, sales and other presentations and demonstrations, systems biology, finance, economy, entertainment or gaming.

37. A method of using the program or medium storing said program as defined in claim 34, for visualisation, manipulation and analysis of virtual representations of objects or for data analysis.

38. A method of using the program or medium storing said program as defined in claim 34, in medicine, drug discovery and development, protein structure discovery, structural science, materials science, materials engineering, prospecting, product design and development, engineering, architecture, nanotechnology, bionanotechnology, electronic circuits design and development, teleoperations, simulation of extraterrestrial environments or conditions, sales and other presentations and demonstrations, systems biology, finance, economy, entertainment or gaming.
